(19) United States
(12) Patent Application Publication
(10) Pub. No.: US 2024/0402522 A1
(43) Pub. Date: Dec. 5, 2024

(54) OPTICAL MODULATOR

(71) Applicant: Murata Manufacturing Co., Ltd., Nagaokakyo-shi (JP)

(72) Inventors: Satoki HAMAMURA, Nagaokakyo-shi (JP); Yasuhiro AIDA, Nagaokakyo-shi (JP)

(21) Appl. No.: 18/804,533

(22) Filed: Aug. 14, 2024

Related U.S. Application Data
(63) Continuation of application No. PCT/JP2023/042862, filed on Nov. 30, 2023.

(30) Foreign Application Priority Data
Mar. 28, 2023 (JP) 2023-051361

(51) Int. Cl. G02F 1/035

(52) U.S. Cl. CPC G02F 1/035

(57) ABSTRACT

An optical modulator includes an optical waveguide and first and second electrodes. The first electrode is located on one side in a height direction of the optical modulator with respect to the optical waveguide. The first electrode includes one end portion and another end portion overlapping with the optical waveguide in a view along the height direction. The second electrode is located on the other side in the height direction with respect to the optical waveguide and applies an electric field to the optical waveguide together with the first electrode. In the view along the height direction, a length of the first electrode is different from a length of the optical waveguide from a position of the one end portion to a position of the another end portion of the first electrode.

### CROSS REFERENCE TO RELATED APPLICATIONS

This application claims the benefit of priority to Japanese Patent Application No. 2023-051361, filed on Mar. 28, 2023, and is a Continuation application of PCT Application No. PCT/JP2023/042862, filed on Nov. 30, 2023 The entire contents of each application are hereby incorporated herein by reference.

### BACKGROUND OF THE INVENTION

### 1. Field of the Invention

The present disclosure relates to optical modulators.

### 2. Description of the Related Art

In optical communication, an optical transceiver that converts an optical signal and an electrical signal into each other is required. The optical transceiver includes an optical modulator as a main component. The optical modulator converts an electrical signal into an optical signal.

For example, U.S. Patent Application Publication No. 2021/0311336 describes a Mach-Zehnder optical modulator. This optical modulator includes first and second optical waveguides, a first ground electrode, a second ground electrode, and a hot electrode. In a plan view of the optical modulator, the hot electrode is located between the first optical waveguide and the second optical waveguide. The first ground electrode is located on a side opposite to the hot electrode with respect to the first optical waveguide and applies an electric field to the first optical waveguide together with the hot electrode. The second ground electrode is located on a side opposite to the hot electrode with respect to the second optical waveguide and applies an electric field to the second optical waveguide together with the hot electrode. The hot electrode, the first ground electrode, and the second ground electrode are located on the same surface.

In the optical modulator of U.S. Patent Application Publication No. 2021/0311336, each of the optical waveguides includes two straight waveguide sections and a bend waveguide section located between the straight waveguide sections. Each of the electrodes includes two straight electrode sections and a bend electrode section located between the straight electrode sections. In the optical modulator of U.S. Patent Application Publication No. 2021/0311336, a difference in length is provided between the bend waveguide section of each optical waveguide and the bend electrode section of the electrode corresponding to the optical waveguide in order to compensate for mismatching between a speed of an electrical signal and a speed of an optical wave.

In the optical modulator of U.S. Patent Application Publication No. 2021/0311336, the first and second optical waveguides, the hot electrode, and the first and second ground electrodes have bend sections in order to compensate for mismatching between the speed of the electrical signal and the speed of the optical wave. In the optical modulator of U.S. Patent Application Publication No. 2021/0311336, application of an unnecessary electric field and absorption of light may occur in one of the first and second optical waveguides particularly in the bend section. For example, as illustrated in FIG. 1 of U.S. Patent Application Publication No. 2021/0311336, a case where a length of the bend section of the electrode is larger than a length of the bend section of the optical waveguide is considered. In the bend section, the second optical waveguide in an inner side portion of the bend in the plan view of the optical modulator does not overlap with any electrode, but the first optical waveguide in an outer side portion of the bend in the plan view of the optical modulator overlaps with the first ground electrode. For example, as illustrated in FIG. 2 of U.S. Patent Application Publication No. 2021/0311336, a case where the length of the bend section of the optical waveguide is larger than the length of the bend section of the electrode is also considered. In the bend section, the first optical waveguide in the outer side portion of the bend in the plan view of the optical modulator does not overlap with any electrode, but the second optical waveguide in the inner side portion of the bend in the plan view of the optical modulator overlaps with the second ground electrode. Accordingly, in the bend section, an electric field may be unnecessarily applied to only one of the first and second optical waveguides, and light may be absorbed by the electrode from any optical waveguide.

### SUMMARY OF THE INVENTION

Example embodiments of the present invention provide optical modulators that are each able to reduce or prevent application of an unnecessary electric field and absorption of light in an optical waveguide and to compensate for mismatching between a speed of an electrical signal and a speed of an optical wave.

An optical modulator according to an example embodiment of the present invention includes an optical waveguide, a first electrode, and a second electrode. The optical waveguide has an electro-optical effect. The first electrode is located on one side in a height direction of the optical modulator with respect to the optical waveguide. The first electrode includes one end portion and another end portion that overlap with at least the optical waveguide in a view along the height direction and extends from the one end portion to the other end portion. The second electrode is located on another side in the height direction with respect to the optical waveguide. The second electrode produces a difference in potential with the first electrode and applies an electric field to the optical waveguide together with the first electrode. In the view along the height direction, a length of the first electrode is different from a length of the optical waveguide from a position of the one end portion to a position of the other end portion of the first electrode.

According to example embodiments of the present invention, application of unnecessary electric fields and absorption of light in the optical waveguide are able to be reduced or prevented, and mismatching between a speed of an electrical signal and a speed of an optical wave can be compensated for.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a plan view of an optical modulator according to a first example embodiment of the present invention.

FIG. 2 is a cross-sectional view taken along a line II-II in FIG. 1.

FIG. 3 is a cross-sectional view taken along a line III-III in FIG. 1.

FIG. 4 is a schematic diagram illustrating a configuration of an optical modulator according to a second example embodiment of the present invention.

FIG. 5 is a schematic diagram illustrating a configuration of an optical modulator according to a third example embodiment of the present invention.

FIG. 6 is a schematic diagram illustrating a configuration of an optical modulator according to a fourth example embodiment of the present invention.

FIG. 7 is a schematic diagram illustrating a configuration of the optical modulator according to the fourth example embodiment of the present invention.

FIG. 8 is a schematic diagram illustrating a configuration of an optical modulator according to a fifth example embodiment of the present invention.

FIG. 9 is a schematic diagram illustrating a configuration of the optical modulator according to the fifth example embodiment of the present invention.

FIG. 10 is a schematic diagram illustrating a configuration of a modified example of the optical modulator according to the fifth example embodiment of the present invention.

FIG. 11 is a is schematic diagram illustrating a configuration of a modified example of the optical modulator according to the fifth example embodiment of the present invention.

FIG. 12A is a schematic diagram illustrating a configuration of an optical modulator according to a sixth example embodiment of the present invention.

FIG. 12B is a schematic diagram illustrating a configuration of the optical modulator according to the sixth example embodiment of the present invention.

FIG. 12C is a schematic diagram illustrating a configuration of the optical modulator according to the sixth example embodiment of the present invention.

FIG. 12D is a schematic diagram illustrating a configuration of the optical modulator according to the sixth example embodiment of the present invention.

FIG. 13A is a schematic diagram illustrating a configuration of the optical modulator according to the sixth example embodiment of the present invention.

FIG. 13B is a schematic diagram illustrating a configuration of the optical modulator according to the sixth example embodiment of the present invention.

FIG. 13C is a schematic diagram illustrating a configuration of the optical modulator according to the sixth example embodiment of the present invention.

FIG. 13D is a schematic diagram illustrating a configuration of the optical modulator according to the sixth example embodiment of the present invention.

FIG. 14 is a schematic diagram illustrating a configuration of an optical modulator according to a seventh example embodiment of the present invention.

FIG. 15 is a schematic diagram illustrating a configuration of an optical modulator according to an eighth example embodiment of the present invention.

### DETAILED DESCRIPTION OF THE EXAMPLE EMBODIMENTS

Hereinafter, example embodiments of the present invention will be described. While the example embodiments of the present invention will be illustratively described in the following description, the present invention is not limited to the examples described below. While specific numerical values and specific materials may be illustrated in the following description, the present disclosure is not limited to the illustrations.

An optical modulator according to an example embodiment of the present invention includes an optical waveguide, a first electrode, and a second electrode. The optical waveguide has an electro-optical effect. The first electrode is located on one side in a height direction of the optical modulator with respect to the optical waveguide. The first electrode includes one end portion and the other end portion that overlap with at least the optical waveguide in a view along the height direction and extends from the one end portion to the other end portion. The second electrode is located on the other side in the height direction with respect to the optical waveguide. The second electrode produces a difference in potential with the first electrode and applies an electric field to the optical waveguide together with the first electrode. In the view along the height direction, a length of the first electrode is different from a length of the optical waveguide from a position of the one end portion to a position of the other end portion of the first electrode (first configuration).

In the first configuration, in a view of the optical modulator along the height direction, the length of the first electrode is different from the length of the optical waveguide from the position of the one end portion to the position of the other end portion of the first electrode. Accordingly, compensation for mismatching between a speed of an electrical signal and a speed of an optical wave can be made.

In a case where at least one of the first electrode and the optical waveguide is bent in order to set the length of the first electrode to be different from a length of a portion of the optical waveguide corresponding to the first electrode, a portion of the optical waveguide may be significantly separated from the first electrode in the view along the height direction of the optical modulator, and there may be a portion of the optical waveguide to which it is difficult to apply the electric field. However, in a case where a plurality of electrodes including the first electrode and the second electrode are located on the same surface and where the optical waveguide is located between the first electrode and the second electrode in the view along the height direction, the portion of the optical waveguide significantly separated from the first electrode may overlap with, for example, the second electrode located parallel to the first electrode, and the electric field generated between the second electrode and another electrode may be unintentionally applied to the portion. Regardless of the fact that the portion of the optical waveguide significantly separated from the first electrode is a portion for which application of the electric field is not intended, the portion being close to the second electrode may unnecessarily increase absorption of light in the second electrode from the optical waveguide.

In the first configuration, the second electrode is located on a side opposite to the first electrode with respect to the optical waveguide in the height direction of the optical modulator. Thus, even in a case where a portion of the optical waveguide is significantly separated from the first electrode in the view along the height direction of the optical modulator, disposition of the second electrode can be relatively freely adjusted so that the portion of the optical waveguide significantly separated from the first electrode does not overlap with, for example, the second electrode. Accordingly, unnecessary electric fields are unlikely to be applied to the optical waveguide, and absorption of light can be reduced.

In the optical modulator of the first configuration, two optical waveguides can be connected to each other in both end portions, the first electrode can be provided to correspond to each of the optical waveguides, and the second electrode can be provided to correspond to each of the optical waveguides (second configuration).

In the optical modulator of the second configuration, the optical waveguide may include two waveguide body portions and a waveguide bend portion that connects individual ends of the two waveguide body portions to each other. In this case, the first electrode may include two electrode body portions overlapping with the two waveguide body portions, respectively, in the view along the height direction and an electrode bend portion that connects individual ends of the two electrode body portions to each other and that is located inside or outside of the waveguide bend portion in the view along the height direction, and a length of the electrode bend portion may be different from a length of the waveguide bend portion (third configuration).

In the third configuration, the individual ends of the two waveguide body portions are connected to each other by the waveguide bend portion, and the individual ends of the two electrode body portions are connected to each other by the electrode bend portion. The electrode bend portion is located inside or outside of the waveguide bend portion in the view along the height direction, and the length of the electrode bend portion is different from the length of the waveguide bend portion. In this case, since the electrode bend portion is separated from the waveguide bend portion in the view along the height direction, it is difficult to apply the electric field to the optical waveguide at a position of the waveguide bend portion. Since the waveguide bend portion of the optical waveguide is a portion to which application of the electric field by the first electrode is not intended, it is desirable not to unnecessarily apply the electric field from the other electrode. In the third configuration, as in the first configuration, since the second electrode is located on a side opposite to the first electrode with respect to the optical waveguide in the height direction of the optical modulator, disposition of the second electrode can be relatively freely adjusted, and the second electrode can also be separated from the waveguide bend portion at the waveguide bend portion. Accordingly, application of unnecessary electric fields to the optical waveguide can be reduced or prevented, and absorption of light can be reduced or prevented.

In the optical modulator of the second configuration or the third configuration, it is preferable that in the view along the height direction, lengths between both end portions of the two optical waveguides are equal or substantially equal to each other (fourth configuration). In this case, an amount of time in which light passes from the one end portion to the other end portion can be set to be the same or substantially the same in the two optical waveguides. Accordingly, an application timing and design of an electrical signal from the first electrode are facilitated.

In the optical modulator of any one of the first configuration to the fourth configuration, an effective refractive index of an electrical signal that passes between the first electrode and the second electrode may be smaller than an effective refractive index of an optical wave that passes through the optical waveguide (fifth configuration). In this case, since the effective refractive index of the electrical signal is smaller than the effective refractive index of the optical wave, a loss of the electrical signal can be reduced.

In the optical modulator of the fifth configuration, it is preferable that the length of the first electrode is larger than the length of the optical waveguide (sixth configuration). In a case where the effective refractive index of the electrical signal is smaller than the effective refractive index of the optical wave, setting the length of the first electrode to be larger than the length of the optical waveguide can match different speeds of the electrical signal and the optical wave. Consequently, a band width of the optical modulator can be expanded.

In the optical modulator of any one of the first configuration to the sixth configuration, the first electrode may include a zigzag portion (seventh configuration). In this case, a path of the first electrode in the zigzag portion has a periodic wave shape. Accordingly, application intensity of the electric field to the optical waveguide is likely to be uniform along the optical waveguide, and signal quality of optical modulation is improved. Variation in the effective refractive indexes depending on a place can be reduced, and reduction of the band width caused by mismatching between the speeds can be reduced or prevented. Since the length of the first electrode can be set to be larger than the length of the optical waveguide, it is likely to obtain an advantageous effect of compensating for mismatching between the speeds.

In the optical modulator of any one of the first configuration to the fourth configuration, an effective refractive index of an electrical signal that passes between the first electrode and the second electrode may be larger than an effective refractive index of an optical wave that passes through the optical waveguide (eighth configuration). In this case, since the application intensity of the electric field to the optical waveguide is further increased, a driving voltage applied to the first electrode can be reduced.

In the optical modulator of the eighth configuration, it is preferable that the length of the optical waveguide is larger than the length of the first electrode (ninth configuration). In a case where the effective refractive index of the electrical signal is larger than the effective refractive index of the optical wave, the application intensity of the electric field to the optical waveguide can be increased even in a case where, for example, a low dielectric constant layer is interposed between the first electrode and the optical waveguide and/or the second electrode and the optical waveguide, by reducing an amount of interposition of the low dielectric constant layer. In this case, the amount of interposition of the low dielectric constant layer is reduced compared to that of an electro-optical material. Thus, the effective refractive index of the electrical signal significantly depends on a dielectric constant of the electro-optical material. Accordingly, since the effective refractive index of the electrical signal is larger than the effective refractive index of the optical wave, it is likely to reduce a band of the optical modulator. Therefore, as in the ninth configuration, in a case where the length of the optical waveguide is set to be larger than the length of the first electrode with respect to a difference in speed between the electrical signal and the optical wave that has occurred, the difference in speed can be corrected, and the optical modulator can be used in a wide band.

In the optical modulator of any one of the first configuration to the fourth configuration, the eighth configuration, and the ninth configuration, the optical waveguide may include a zigzag portion (tenth configuration). In this case, a path of the optical waveguide in the zigzag portion has a periodic wave shape. Accordingly, the application intensity of the electric field to the optical waveguide is likely to be uniform along the optical waveguide, and signal quality of optical modulation is improved. Variation in the effective refractive indexes depending on a place can be reduced, and reduction of the band width caused by mismatching between the speeds can be reduced or prevented. Since the length of the optical waveguide can be set to be larger than the length of the first electrode, it is likely to obtain the effect of compensating for mismatching between the speeds.

The optical modulator of any one of the first configuration to the tenth configuration can further include an input port to input light into the optical waveguide, and an output port to output light from the optical waveguide. In this case, it is preferable that the input port is located on an end surface of the optical modulator along the height direction, and the output port is located on the end surface (eleventh configuration). In this case, for example, processing of coupling an optical fiber and an optical coupler to the input port and the output port can be performed at one place. Thus, a processing time can be reduced, and the number of members can be reduced.

Hereinafter, example embodiments of the present invention will be described with reference to the accompanying drawings. The same or corresponding configurations in each drawing are designated by the same reference numerals, and duplicate descriptions thereof will not be repeated.

### First Example Embodiment

### Configuration of Optical Modulator

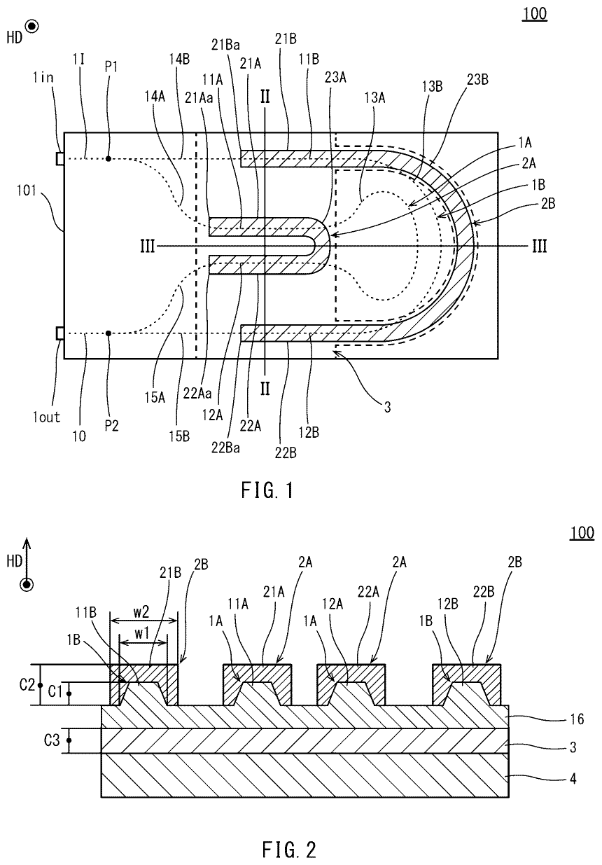

FIG. 1 is a plan view of an optical modulator 100 according to a first example embodiment of the present invention. With reference to FIG. 1, the optical modulator 100 is a Mach-Zehnder optical modulator in the example of the present example embodiment. The optical modulator 100 preferably includes two optical waveguides 1A and 1B, two first electrodes 2A and 2B, and a second electrode 3. FIG. 1 illustrates the optical waveguides 1A and 1B, the first electrodes 2A and 2B, and the second electrode 3 that are projected to a plane perpendicular or substantially perpendicular to a height direction HD of the optical modulator 100. In FIG. 1, the optical waveguides 1A and 1B are illustrated by dotted lines, and the second electrode 3 is illustrated by a broken line. In the present specification, the height direction HD means a lamination direction of elements of the optical modulator 100 having a laminated structure.

The optical waveguides 1A and 1B function as a light transmission path. The two optical waveguides 1A and 1B are connected to each other at their both end portions. Specifically, each of the optical waveguides 1A and 1B is connected to an input-side optical waveguide 1I at a branch point P1 that is one end portion, and are connected to an output-side optical waveguide 10 at a junction point P2 that is the other end portion. That is, the optical waveguides 1A and 1B branch from the input-side optical waveguide 1I at the branch point P1 and join the output-side optical waveguide 10 at the junction point P2.

In the present example embodiment, the optical modulator 100 includes an input port 1in to input light into the optical waveguides 1A and 1B and an output port 1out to output light from the optical waveguides 1A and 1B. The input port 1in is provided at a tip end portion of the input-side optical waveguide 1I and is connected to the branch point P1 of the optical waveguides 1A and 1B through the input-side optical waveguide 1I. The output port 1out is provided at a tip end portion of the output-side optical waveguide 10 and is connected to the junction point P2 of the optical waveguides 1A and 1B through the output-side optical waveguide 10. In the example of the present example embodiment, both of the input port 1in and the output port 1out are located on an end surface 101 of the optical modulator 100 along the height direction. That is, the input port 1in and the output port 1out are provided on the same end surface 101 of the optical modulator 100.

In the present example embodiment, the two optical waveguides 1A and 1B are bent to be folded. The optical waveguide 1A is located inside of the optical waveguide 1B. The optical waveguide 1A includes two body portions 11A and 12A and a bend portion 13A that connects individual ends of the two body portions 11A and 12A to each other. The optical waveguide 1A preferably further includes an input-side connection portion 14A and an output-side connection portion 15A. The input-side connection portion 14A connects the body portion 11A to the branch point P1. The output-side connection portion 15A connects the body portion 12A to the junction point P2.

The optical waveguide 1B includes two body portions 11B and 12B and a bend portion 13B that connects individual ends of the two body portions 11B and 12B to each other. The optical waveguide 1B further includes an input-side connection portion 14B and an output-side connection portion 15B. The input-side connection portion 14B connects the body portion 11B to the branch point P1. The output-side connection portion 15B connects the body portion 12B to the junction point P2.

A length between both end portions of the optical waveguide 1A is the same or substantially the same as a length between both end portions of the optical waveguide 1B. The fact that the length between both end portions of the optical waveguide 1A is the same or substantially the same as the length between both end portions of the optical waveguide 1B means that the both lengths are substantially equal, and a difference between both lengths, for example, is about half or less of a wavelength of an input optical wave. The length between both end portions of the optical waveguide 1A may be different from the length between both end portions of the optical waveguide 1B. In the present specification, the length between both end portions of the optical waveguide 1A means a length of the entire optical waveguide 1A, that is, a length of the optical waveguide 1A from the branch point P1 to the junction point P2. Similarly, a length of the optical waveguide 1B means the length of the entire optical waveguide 1B, that is, a length of the optical waveguide 1B from the branch point P1 to the junction point P2.

In the optical waveguide 1A, the body portion 11A and the body portions 12A are located parallel or substantially parallel to each other. In the example of the present example embodiment, the body portions 11A and 12A have a straight shape. The body portions 11A and 12A may extend in a substantially straight shape. For example, the body portion 11A and the body portion 12A are located parallel or substantially parallel to each other. A length of the body portion 11A is the same or substantially the same as a length of the body portion 12A. The length of the body portion 11A may be different from the length of the body portion 12A.

In the optical waveguide 1A, the bend portion 13A connects individual ends of the body portions 11A and 12A to each other. The bend portion 13A is connected to an end portion of the body portion 11A on a side opposite to the input-side connection portion 14A and an end portion of the body portion 12A on a side opposite to the output-side connection portion 15A. In the example illustrated in FIG. 1, the bend portion 13A has a curved shape that is convex to a side opposite to the branch point P1 and the junction point P2 with respect to the body portions 11A and 12A in a view along the height direction HD. The optical waveguide 1A is folded by the bend portion 13A.

In the optical waveguide 1B, the body portion 11B and the body portion 12B are located parallel or substantially parallel to each other. In the example of the present example embodiment, the body portions 11B and 12B have a straight shape. The body portions 11B and 12B may extend in a substantially straight shape. For example, the body portion 11B and the body portion 12B are located parallel or substantially parallel to each other. A length of the body portion 11B is the same or substantially the same as a length of the body portion 12B. The length of the body portion 11B may be different from the length of the body portion 12B. The lengths of the body portions 11B and 12B in the optical waveguide 1B are the same or substantially the same as the lengths of the body portions 11A and 12A in the optical waveguide 1A.

In the optical waveguide 1B, the bend portion 13B connects individual ends of the body portions 11B and 12B to each other. The bend portion 13B is connected to an end portion of the body portion 11B on a side opposite to the input-side connection portion 14B and an end portion of the body portion 12B on a side opposite to the output-side connection portion 15B. In the example illustrated in FIG. 1, the bend portion 13B has a curved shape that is convex to a side opposite to the branch point P1 and the junction point P2 with respect to the body portions 11B and 12B in the view along the height direction HD. The optical waveguide 1B is folded by the bend portion 13B. The bend portion 13B of the optical waveguide 1B is located outside of the bend portion 13A of the optical waveguide 1A. A length of the bend portion 13B in the optical waveguide 1B is the same or substantially the same as a length of the bend portion 13A in the optical waveguide 1A.

The first electrodes 2A and 2B are located on one side in the height direction HD of the optical modulator 100 with respect to the optical waveguides 1A and 1B. The first electrodes 2A and 2B include one end portions 21Aa and 21Ba and other end portions 22Aa and 22Ba that overlap with at least the optical waveguides 1A and 1B in the view along the height direction HD. The first electrodes 2A and 2B extend from the one end portions 21Aa and 21Ba to the other end portions 22Aa and 22Ba. Hereinafter, configurations of the first electrodes 2A and 2B will be specifically described.

The first electrode 2A is located inside of the first electrode 2B. The first electrode 2A includes two body portions 21A and 22A and a bend portion 23A that connects individual ends of the two body portions 21A and 22A to each other. Wires (not illustrated) are connected to the body portions 21A and 22A in order to supply an electrical signal to the first electrode 2A or acquire an electrical signal from the first electrode 2A. For example, the wire to supply the electrical signal is connected to the end portion 21Aa on a side opposite to the bend portion 23A with respect to the body portion 21A. The wire to acquire the electrical signal is connected to the end portion 22Aa on a side opposite to the bend portion 23A with respect to the body portion 22A.

In the first electrode 2A, the body portion 21A and the body portion 22A are located parallel or substantially parallel to each other. The body portion 21A of the first electrode 2A overlaps with the body portion 11A of the optical waveguide 1A. For example, the body portion 21A is provided along the body portion 11A. The body portion 22A of the first electrode 2A overlaps with the body portion 12A of the optical waveguide 1A. For example, the body portion 21A is provided along the body portion 11A. In the example of the present example embodiment, the body portions 21A and 22A have a straight shape. The body portions 21A and 22A may overlap with the body portions 11A and 12A of the optical waveguide 1A. For example, the body portion 21A and the body portion 22A are located parallel or substantially parallel to each other.

In the first electrode 2A, the bend portion 23A connects individual ends of the body portions 21A and 22A to each other. The bend portion 23A is connected to an end portion of the body portion 21A on a side opposite to the end portion 21Aa and an end portion of the body portion 22A on a side opposite to the end portion 22Aa. In the example illustrated in FIG. 1, the bend portion 23A has a curved shape that is convex to a side opposite to the one end portion 21Aa and the other end portion 22Aa with respect to the body portions 21A and 22A in the view along the height direction HD. The first electrode 2A is folded by the bend portion 23A. The bend portion 23A of the first electrode 2A is located inside of the bend portion 13A of the optical waveguide 1A and substantially does not overlap with the optical waveguide 1A. The bend portion 23A may overlap with the body portions 11A and 12A of the optical waveguide 1A near the body portions 21A and 22A. In this case, the bend portion 13A of the optical waveguide 1A has a portion that is significantly separated from the bend portion 23A of the first electrode 2A. A length of the bend portion 23A of the first electrode 2A is smaller than the length of the bend portion 13A of the optical waveguide 1A.

A length of the first electrode 2A is smaller than a length of the optical waveguide 1A from a position of the one end portion 21Aa to a position of the other end portion 22Aa of the first electrode 2A in the view along the height direction HD. The length of the first electrode 2A is a sum of a length of each of the body portions 21A and 22A and the length of the bend portion 23A. An end portion in which the overlapping between the optical waveguide 1A and the first electrode 2A starts is the one end portion 21Aa of the first electrode 2A (body portion 21A), and an end portion in which the overlapping ends is the other end portion 22Aa of the first electrode 2A (body portion 22A). Accordingly, the length of the optical waveguide 1A may be a sum of the length of each of the body portions 11A and 12A and the length of the bend portion 13A.

The first electrode 2B includes two body portions 21B and 22B and a bend portion 23B that connects individual ends of the two body portions 21B and 22B to each other. Wires (not illustrated) are connected to the body portions 21B and 22B in order to supply an electrical signal to the first electrode 2B or acquire an electrical signal from the first electrode 2B. For example, the wire to supply the electrical signal is connected to the end portion 21Ba on a side opposite to the bend portion 23B with respect to the body portion 21B. The wire to acquire the electrical signal is connected to the end portion 22Ba on a side opposite to the bend portion 23B with respect to the body portion 22B.

In the first electrode 2B, the body portion 21B and the body portion 22B are located parallel or substantially parallel to each other. The body portion 21B of the first electrode 2B overlaps with the body portion 11B of the optical waveguide 1B. For example, the body portion 21B is provided along the body portion 11B. The body portion 22B of the first electrode 2B overlaps with the body portion 12B of the optical waveguide 1B. For example, the body portion 21B is provided along the body portion 11B. In the example of the present example embodiment, the body portions 21B and 22B have a straight shape. The body portions 21B and 22B may overlap with the body portions 11B and 12B of the optical waveguide 1B. For example, the body portion 21B and the body portion 22B are located parallel or substantially parallel to each other.

In the first electrode 2B, the bend portion 23B connects individual ends of the body portions 21B and 22B to each other. The bend portion 23B is connected to an end portion of the body portion 21B on a side opposite to the end portion 21Ba and an end portion of the body portion 22B on a side opposite to the end portion 22Ba. In the example illustrated in FIG. 1, the bend portion 23B has a curved shape that is convex to a side opposite to the one end portion 21Ba and the other end portion 22Ba with respect to the body portions 21B and 22B in the view along the height direction HD. The first electrode 2B is folded by the bend portion 23B. The bend portion 23B of the first electrode 2B is located outside of the bend portion 13B of the optical waveguide 1B and substantially does not overlap with the optical waveguide 1B. The bend portion 23B may overlap with the body portions 11B and 12B of the optical waveguide 1B near the body portions 21B and 22B. In this case, the bend portion 13B of the optical waveguide 1B includes a portion that is significantly separated from the bend portion 23B of the first electrode 2B. A length of the bend portion 23B of the first electrode 2B is larger than the length of the bend portion 13B of the optical waveguide 1B.

A length of the first electrode 2B is larger than the length of the optical waveguide 1B from a position of the one end portion 21Ba to a position of the other end portion 22Ba of the first electrode 2B in the view along the height direction HD. The length of the first electrode 2B is a sum of a length of each of the body portions 21B and 22B and the length of the bend portion 23B. An end portion in which the overlapping between the optical waveguide 1B and the first electrode 2B starts is the one end portion 21Ba of the first electrode 2B (body portion 21B), and an end portion in which the overlapping ends is the other end portion 22Ba of the first electrode 2B (body portion 22B). Accordingly, the length of the optical waveguide 1B may be a sum of the length of each of the body portions 11B and 12B and the length of the bend portion 13B.

In the present example embodiment, as described above, the length of the first electrode 2A is smaller than the length of the optical waveguide 1A. The length of the first electrode 2B is larger than the length of the optical waveguide 1B. Accordingly, the length of the first electrode 2A is different from the length of the optical waveguide 1A from the position of the one end portion 21Aa to the position of the other end portion 22Aa of the first electrode 2A. The length of the first electrode 2B is different from the length of the optical waveguide 1B from the position of the one end portion 21Ba to the position of the other end portion 22Ba of the first electrode 2B.

The second electrode 3 is located to at least partially overlap with the optical waveguides 1A and 1B and the first electrodes 2A and 2B in the view along the height direction HD. For example, in the view along the height direction HD, the second electrode 3 overlaps with the body portions 11A, 12A, 11B, and 12B of the optical waveguides 1A and 1B and overlaps with the body portions 21A, 22A, 21B, 22B and the bend portions 23A and 23B of the first electrodes 2A and 2B. In this case, at least the one end portion 21Aa and the other end portion 22Aa of the first electrode 2A overlap with the second electrode 3 in the view along the height direction HD. At least the one end portion 21Ba and the other end portion 22Ba of the first electrode 2B overlap with the second electrode 3 in the view along the height direction HD.

The second electrode 3 produces a difference in potential with respect to each of the body portions 21A, 22A, 21B, and 22B of the first electrodes 2A and 2B and applies an electric field to the body portions 11A, 12A, 11B, and 12B of the optical waveguides 1A and 1B together with the first electrodes 2A and 2B. The first electrode 2A and 2B and the second electrode 3 define and function as, for example, a control electrode to control light that passes through the optical waveguides 1A and 1B. The body portion 21A of the first electrode 2A and the second electrode 3 are disposed to be capable of applying an electric field to the body portion 11A of the optical waveguide 1A. The body portion 22A of the first electrode 2A and the second electrode 3 are disposed to be capable of applying an electric field to the body portion 12A of the optical waveguide 1A. The body portion 21B of the first electrode 2B and the second electrode 3 are disposed to be capable of applying an electric field to the body portion 11B of the optical waveguide 1B. The body portion 22B of the first electrode 2B and the second electrode 3 are disposed to be capable of applying an electric field to the body portion 12B of the optical waveguide 1B. The body portions 11A, 12A, 11B, and 12B are substantially optical modulation portions of the optical waveguides 1A and 1B. For example, the first electrodes 2A and 2B can be used as a signal electrode, and the second electrode 3 can be used as a ground electrode. The first electrodes 2A and 2B may be used as a ground electrode, and the second electrode 3 may be used as a signal electrode.

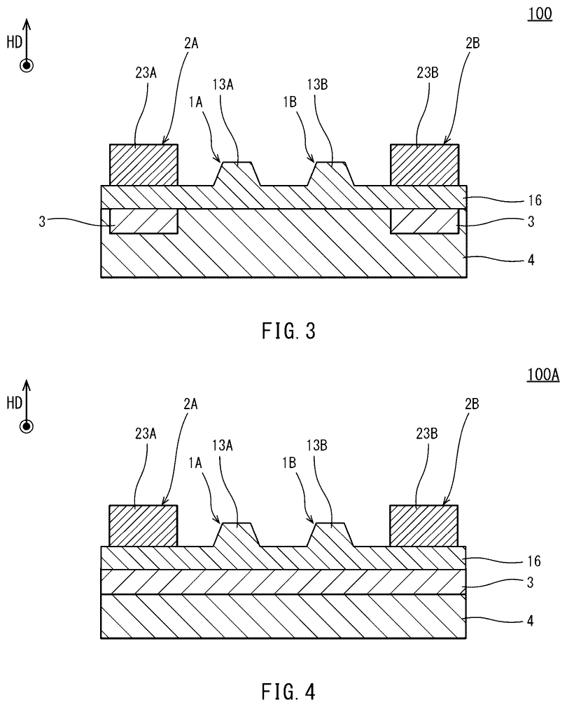

A configuration of the optical modulator 100 illustrated in FIG. 1 will be more specifically described with reference to FIGS. 2 and 3. FIG. 2 is a cross-sectional view taken along a line II-II in FIG. 1. In other words, FIG. 2 is a cross-sectional view in a case where the optical modulator 100 is cut in a plane along the height direction HD at positions of the body portions 11A, 12A, 11B, and 12B of the optical waveguides 1A and 1B (the optical modulation portions of the optical waveguides 1A and 1B).

With reference to FIG. 2, the optical waveguides 1A and 1B have an electro-optical effect. As described above, the optical waveguide 1A includes the body portions 11A and 12A and the bend portion 13A (FIGS. 1 and 3). The optical waveguide 1B includes the body portions 11B and 12B and the bend portion 13B (FIGS. 1 and 3).

In the example of the present example embodiment, the optical waveguides 1A and 1B are formed in a base layer 16. In the example of the present example embodiment, the optical waveguides 1A and 1B protrude from a surface of the base layer 16. That is, the optical waveguides 1A and 1B are, for example, ridged optical waveguides. The optical waveguides 1A and 1B are not necessarily ridged optical waveguides. While the optical waveguides 1A and 1B may have a trapezoidal or substantially trapezoidal cross section as illustrated in FIG. 2, the optical waveguides 1A and 1B can have cross sections of other shapes such as a rectangular or substantially rectangular shape.

The optical waveguides 1A and 1B have the electro-optical effect. That is, the optical waveguides 1A and 1B are made of an electro-optical material. For example, lithium niobate (LiNbO₃), lithium tantalate (LiTaO₃), lead lanthanum zirconate titanate (PLZT), potassium tantalate niobate (KTN), barium titanate (BaTiO₃), or the like can be used as the electro-optical material. An electro-optical polymer (EO polymer), for example, may also be used as the electro-optical material. The base layer 16 may be made of the same electro-optical material as the optical waveguides 1A and 1B. The base layer 16 can be omitted in the optical modulator 100.

The first electrodes 2A and 2B are located on one side in the height direction HD of the optical modulator 100 with respect to the optical waveguides 1A and 1B. That is, centers C2 of the first electrodes 2A and 2B in the height direction HD deviate to one side in the height direction HD from centers C1 of the optical waveguides 1A and 1B in the height direction HD of the optical modulator 100. In the example of the present example embodiment, the entire or substantially the entire body portion 21A of the first electrode 2A is located on one side in the height direction HD with respect to the body portion 11A of the optical waveguide 1A at the positions of the body portions 11A, 12A, 11B, and 12B of the optical waveguides 1A and 1B. The entire or substantially the entire body portion 22A of the first electrode 2A is located on one side in the height direction HD with respect to the body portion 12A of the optical waveguide 1A. The entire or substantially the entire body portion 21B of the first electrode 2B is located on one side in the height direction HD with respect to the body portion 11B of the optical waveguide 1B. The entire or substantially the entire body portion 22B of the first electrode 2B is located on one side in the height direction HD with respect to the body portion 12B of the optical waveguide 1B. In the present example embodiment, the first electrodes 2A and 2B have a rectangular or substantially rectangular cross section. However, cross-sectional shapes of the first electrodes 2A and 2B are not limited to this.

In the present example embodiment, widths w2 of the first electrodes 2A and 2B are larger than widths w1 of the optical waveguides 1A and 1B. Specifically, as illustrated in FIG. 2, the width w2 of the body portion 21B in the first electrode 2B is larger than the width w1 of the body portion 11B in the optical waveguide 1B. The widths w2 of the body portions 21A, 22A, and 22B in the first electrodes 2A and 2B are larger than the widths w1 of the body portions 11A, 12A, and 12B in the optical waveguides 1A and 1B. The widths w2 of the first electrodes 2A and 2B mean the widths at their maximum in a case where the widths w2 change along the height direction HD. The widths w1 of the optical waveguides 1A and 1B mean the widths at their maximum in a case where the widths w1 change along the height direction HD.

With reference to FIG. 2, the same electrical signal flows through the body portions 21A and 22A in the first electrode 2A. Thus, any noticeable problem does not arise even in a case where a separation distance between the body portions 21A and 22A is small. Meanwhile, an electrical signal different from that in the body portion 21B in the first electrode 2B flows through the body portion 21A in the first electrode 2A. Thus, there is an increased probability of cross talk in a case where a separation distance between the body portion 21A and the body portion 21B is small. An electrical signal different from that in the body portion 22B in the first electrode 2B flows through the body portion 22A in the first electrode 2A. Thus, there is an increased probability of cross talk in a case where a separation distance between the body portion 22A and the body portion 22B is small. Accordingly, it is preferable that the separation distance between the body portions 21A and 22A in the first electrode 2A is larger than the separation distance between the body portion 21A and the body portion 21B in the first electrode 2B adjacent to the body portion 21A and larger than the separation distance between the body portion 22A and the body portion 22B in the first electrode 2B adjacent to the body portion 22A.

The optical modulator 100 can further include a support substrate 4. The support substrate 4 can also be omitted in the optical modulator 100. The support substrate 4 supports the optical waveguides 1A and 1B, the first electrodes 2A and 2B, and the second electrodes 3. A semiconductor material can be used as the support substrate 4. A single-element semiconductor of, for example, silicon (Si), germanium (Ge), or the like or a compound semiconductor of gallium arsenide (GaAs) or the like may preferably be used as the semiconductor material. An oxide such as, for example, SiO₂, Al₂O₃, LaAlO₃, LaYO₃, ZnO, HfO₂, MgO, or Y₂O₃ may be used as the support substrate 4. An electro-optical material, specifically, for example, LiNbO₃, LiTaO₃, PLZT, KTN, BaTiO₃, or the like, may also be used as the support substrate 4.

The second electrode 3 is located on the other side (a side opposite to the first electrodes 2A and 2B) in the height direction HD of the optical modulator 100 with respect to each of the optical waveguides 1A and 1B. That is, a center C3 of the second electrode 3 in the height direction HD of the optical modulator 100 deviates to the other side in the height direction HD from the centers C1 of the optical waveguides 1A and 1B. In the example of the present example embodiment, the optical waveguides 1A and 1B are laminated with the second electrode 3 on a side opposite to the first electrodes 2A and 2B in the height direction HD.

More specifically, in the view of the optical modulator 100 along the height direction HD, the body portions 21A, 22A, 21B, and 22B of the first electrodes 2A and 2B overlap with the body portions 11A, 12A, 11B, and 12B of the optical waveguide 1A, as described above. With reference to FIG. 2, the base layer 16 including the optical waveguides 1A and 1B is laminated with the second electrode 3 on a side opposite to the body portions 21A, 22A, 21B, and 22B of the first electrodes 2A and 2B at the positions of the body portions 11A, 12A, 11B, and 12B of the optical waveguides 1A and 1B. The second electrode 3 is located on a side opposite to the first electrodes 2A and 2B with respect to the optical waveguides 1A and 1B such that the positions of the body portions 21A, 22A, 21B, and 22B of the first electrodes 2A and 2B are determined. In the present example embodiment, the second electrode 3 is preferably located to correspond to all of the body portions 21A, 22A, 21B, and 22B of the first electrodes 2A and 2B and the body portions 11A, 12A, 11B, and 12B of the optical waveguides 1A and 1B. In this case, both of the body portions 11A and 12A of the optical waveguide 1A are interposed between the first electrode 2A and the second electrode 3 in the height direction HD. Both of the body portions 11B and 12B of the optical waveguide 1B are interposed between the first electrode 2B and the second electrode 3 in the height direction HD.

FIG. 3 is a cross-sectional view taken along a line III-III in FIG. 1. In other words, FIG. 3 is a cross-sectional view in a case where the optical modulator 100 is cut in a plane along the height direction HD at positions of the bend portions 13A and 13B of the optical waveguides 1A and 1B.

In the view of the optical modulator 100 along the height direction HD, the bend portions 23A and 23B of the first electrodes 2A and 2B do not overlap with the bend portions 13A and 13B of the optical waveguides 1A and 1B, as described above. With reference to FIG. 3, the bend portion 13A of the optical waveguide 1A deviates in a direction perpendicular or substantially perpendicular to the height direction HD from the bend portion 23A of the first electrode 2A at the positions of the bend portions 13A and 13B of the optical waveguides 1A and 1B. The bend portion 13B of the optical waveguide 1B deviates in the direction perpendicular or substantially perpendicular to the height direction HD from the bend portion 23B of the first electrode 2B. For example, a portion of the bend portion 13A of the optical waveguide 1A that deviates the most from the bend portion 23A of the first electrode 2A is separated from the bend portion 23A by a distance greater than or equal to half of a width of the bend portion 23A. A portion of the bend portion 13B of the optical waveguide 1B that deviates the most from the bend portion 23B of the first electrode 2B is separated from the bend portion 23B by a distance greater than or equal to half of a width of the bend portion 23B.

The base layer 16 including the optical waveguides 1A and 1B is laminated with the second electrode 3 on a side opposite to the bend portions 23A and 23B of the first electrodes 2A and 2B. In the present example embodiment, the second electrode 3 is located to correspond to the bend portions 23A and 23B of the first electrodes 2A and 2B. The second electrode 3 is not provided at positions corresponding to the bend portions 13A and 13B of the optical waveguides 1A and 1B. That is, the second electrode 3 does not overlap with portions of the bend portions 13A and 13B of the optical waveguides 1A and 1B that is separated from the first electrodes 2A and 2B in the view along the height direction HD of the optical modulator 100. In this case, the bend portion 13A of the optical waveguide 1A is not interposed between the first electrode 2A and the second electrode 3 in the height direction HD. The bend portion 13B of the optical waveguide 1B is also not interposed between the first electrode 2B and the second electrode 3 in the height direction HD. Other electrodes that are close to the bend portions 13A and 13B of the optical waveguides 1A and 1B are also not present.

In the example of the present example embodiment, the second electrode 3 is provided in common for the two optical waveguides 1A and 1B. The second electrode 3 may be provided for each of the optical waveguides 1A and 1B.

### Advantageous Effects

The optical modulator is desirably usable in a wide band including a high-frequency band of, for example, about 10 GHz or more and about 1.5 THz or less and preferably matches the speed of the electrical signal and the speed of the optical wave. To do so, any one of the length of the optical waveguide and the length of the control electrode is set to be larger than the other instead of setting the lengths to be the same. By doing so, a difference in a propagation distance caused by a difference in speed between the electrical signal and the optical wave can be reduced, and compensation for mismatching between the speeds of the electrical signal and the optical wave can be made. In the optical modulator 100 according to the present example embodiment, in the first electrodes 2A and 2B that apply the electric field to the optical waveguides 1A and 1B together with the second electrode 3, the one end portions 21Aa and 21Ba and the other end portions 22Aa and 22Ba of the first electrodes 2A and 2B overlap with the optical waveguides 1A and 1B in the view along the height direction HD. The lengths of the first electrodes 2A and 2B are set to be different from the lengths of the optical waveguides 1A and 1B from the positions of the one end portions 21Aa and 21Ba to the positions of the other end portions 22Aa and 22Ba of the first electrodes 2A and 2B. Accordingly, compensation for mismatching between the speed of the electrical signal and the speed of the optical wave can be made. For example, in a case where an effective refractive index of the electrical signal is smaller than an effective refractive index of the optical wave in the optical modulator, it is preferable that the lengths of the first electrodes 2A and 2B are larger than the lengths of the optical waveguides 1A and 1B from the positions of the one end portions 21Aa and 21Ba to the positions of the other end portions 22Aa and 22Ba of the first electrodes 2A and 2B. For example, in a case where the effective refractive index of the electrical signal is larger than the effective refractive index of the optical wave in the optical modulator, the lengths of the optical waveguides 1A and 1B may be set to be larger than the lengths of the first electrodes 2A and 2B.

In the optical modulator 100 according to the present example embodiment, in the view along the height direction HD, the bend portion 23A that connects the two body portions 21A and 22A in the first electrode 2A is located inside of the bend portion 13A that connects the two body portions 11A and 12A in the optical waveguide 1A, and the length of the bend portion 23A of the first electrode 2A is smaller than the length of the bend portion 13A of the optical waveguide 1A. The bend portion 23B that connects the two body portions 21B and 22B in the first electrode 2B is located outside of the bend portion 13B that connects the two body portions 11B and 12B in the optical waveguide 1B, and the length of the bend portion 23B of the first electrode 2B is larger than the length of the bend portion 13B of the optical waveguide 1B. In this case, the bend portions 23A and 23B of the first electrodes 2A and 2B are separated from the bend portions 13A and 13B of the optical waveguides 1A and 1B, respectively, in the view along the height direction HD. Thus, it is difficult to apply an electric field to the optical waveguides 1A and 1B at the positions of the bend portions 13A, 13B of the optical waveguides 1A and 1B, respectively. The bend portions 13A and 13B of each of the optical waveguides 1A and 1B are portions for which application of the electric field by the first electrodes 2A and 2B is not intended. Thus, it is preferable not to apply unnecessary electric fields to the bend portions 13A and 13B of each of the optical waveguides 1A and 1B from other irrelevant electrodes. For example, it is preferable not to apply an electric field to the bend portion 13A of the optical waveguide 1A from the irrelevant first electrode 2B.

In the optical modulator 100 according to the present example embodiment, the second electrode 3 is located on a side opposite to the first electrodes 2A and 2B with respect to the optical waveguides 1A and 1B in the height direction HD of the optical modulator 100. That is, the second electrode 3 is located on different surfaces of the optical waveguides 1A and 1B from the first electrodes 2A and 2B. Thus, disposition of the second electrode 3 can be relatively freely adjusted, and the other irrelevant electrodes can be disposed such that unnecessary electric fields are not applied to the bend portions 13A and 13B of each of the optical waveguides 1A and 1B from the other electrodes. For example, it is possible not to apply an electric field to the bend portion 13A of the optical waveguide 1A from the irrelevant first electrode 2B and also not to apply an electric field between the bend portion 13A of the optical waveguide 1A and the second electrode 3. Accordingly, application of unnecessary electric fields to the optical waveguides 1A and 1B can be reduced or prevented, and absorption of light can be reduced or prevented. As a result of the fact that unnecessary electric fields are unlikely to be applied to the optical waveguides 1A and 1B, noise can be reduced.

In the optical modulator 100 according to the present example embodiment, in the view along the height direction HD, the length between both end portions of the optical waveguide 1A is the same or substantially the same as the length of the optical waveguide 1B. That is, in the view of the optical modulator 100 along the height direction HD, the lengths between both end portions of the two optical waveguides 1A and 1B are equal or substantially equal to each other. In this case, an amount of time in which light passes from one end portion to the other end portion can be set to be the same in the two optical waveguides 1A and 1B. Accordingly, an application timing and design of the electrical signals from the first electrodes 2A and 2B are facilitated.

In the optical modulator 100 according to the present example embodiment, both of the input port 1in to input light into the optical waveguides 1A and 1B and the output port 1out to output light from the optical waveguides 1A and 1B are preferably located on the same end surface 101 of the optical modulator 100. An optical fiber and an optical coupler are coupled to the input port 1in and the output port 1out. In a case where the input port 1in and the output port 1out are provided on the same end surface 101 of the optical modulator 100, processing of coupling the optical fiber and the optical coupler to the input port 1in and the output port 1out can be performed at one place. Thus, a processing time can be reduced, and the number of members can be reduced.

In the present example embodiment, the widths w2 of the first electrodes 2A and 2B are larger than the widths w1 of the optical waveguides 1A and 1B. In this case, since the electric field can be uniformly applied to the optical waveguides 1A and 1B, quality of a modulated signal is improved.

### Second Example Embodiment

A configuration of an optical modulator 100A according to a second example embodiment of the present invention will be described with reference to FIG. 4. FIG. 4 is a schematic diagram illustrating a configuration of the optical modulator 100A according to the second example embodiment and is a cross-sectional view corresponding to FIG. 3. In other words, FIG. 4 is a cross-sectional view in a case where the optical modulator 100A is cut in a plane along the height direction HD at the positions of the bend portions 13A and 13B of the optical waveguides 1A and 1B. The optical modulator 100A is different from the optical modulator 100 according to the first example embodiment in a configuration of the second electrode 3.

As illustrated in FIG. 4, in the optical modulator 100A, the base layer 16 including the optical waveguides 1A and 1B is laminated with the second electrode 3 on a side opposite to the bend portions 23A and 23B of the first electrodes 2A and 2B at the positions of the bend portions 13A and 13B of the optical waveguides 1A and 1B. In the present example embodiment, the second electrode 3 is located to correspond to all of the bend portions 23A and 23B of the first electrodes 2A and 2B and the bend portions 13A and 13B of the optical waveguides 1A and 1B. Thus, the second electrode 3 is also provided at the positions corresponding to the bend portions 13A and 13B of the optical waveguides 1A and 1B. In this case, the second electrodes 3 overlaps with the bend portions 13A and 13B separated from the first electrodes 2A and 2B in the optical waveguides 1A and 1B in the view along the height direction HD of the optical modulator 100. However, the bend portion 13A of the optical waveguide 1A is not interposed between the first electrode 2A and the second electrode 3 in the height direction HD. The bend portion 13B of the optical waveguide 1B is also not interposed between the first electrode 2B and the second electrode 3 in the height direction HD.

In the optical modulator 100A according to the present example embodiment, since the bend portions 23A and 23B of the first electrodes 2A and 2B are separated from the bend portions 13A and 13B of the optical waveguide 1A, application of the electric field by the first electrodes 2A and 2B and the second electrode 3 and absorption of light are unlikely to occur with respect to a portion of the optical waveguide 1A (portions of the bend portions 13A and 13B) separated from the first electrodes 2A and 2B by the first electrodes 2A and 2B. Accordingly, as in the first example embodiment, unnecessary electric fields are unlikely to be applied to the optical waveguides 1A and 1B, and absorption of light can be reduced.

### Third Example Embodiment

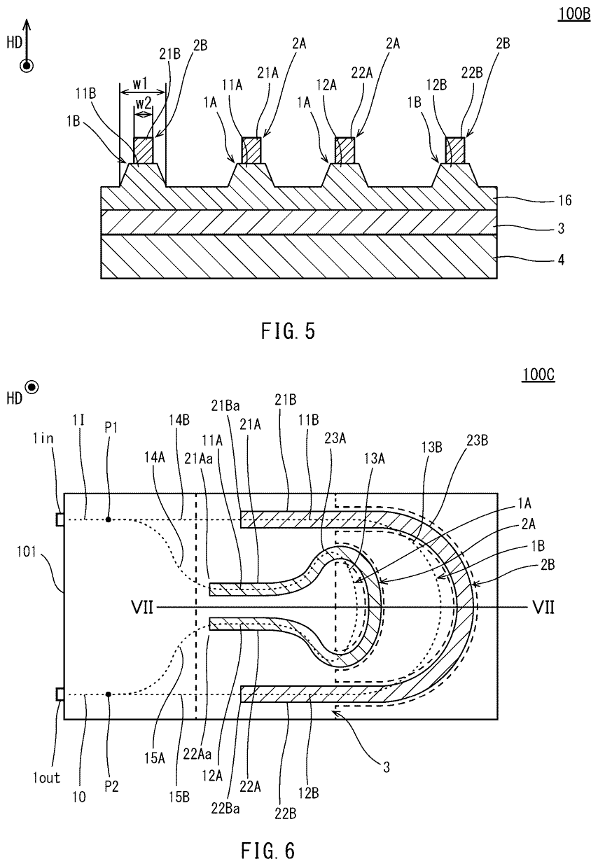

A configuration of an optical modulator 100B according to a third example embodiment of the present invention will be described with reference to FIG. 5. FIG. 5 is a schematic diagram illustrating a configuration of the optical modulator 100B according to the third example embodiment and is a cross-sectional view corresponding to FIG. 2. In other words, FIG. 5 is a cross-sectional view in a case where the optical modulator 100B is cut in a plane along the height direction HD at the positions of the body portions 11A, 12A, 11B, and 12B of the optical waveguides 1A and 1B. The optical modulator 100B is different from the optical modulator 100 according to the first example embodiment in configurations of the first electrodes 2A and 2B.

As illustrated in FIG. 5, in the optical modulator 100B, the widths w2 of the first electrodes 2A and 2B are smaller than the widths w1 of the optical waveguides 1A and 1B. By setting the widths w2 of the first electrodes 2A and 2B to be smaller than the widths w1 of the optical waveguides 1A and 1B, the electric field can be applied to the optical waveguides 1A and 1B in a concentrated manner. Thus, the driving voltage applied to the first electrode can be reduced. Forms of the first electrodes 2A and 2B in the present example embodiment can also be applied to the optical modulator 100A according to the second example embodiment.

### Fourth Example Embodiment

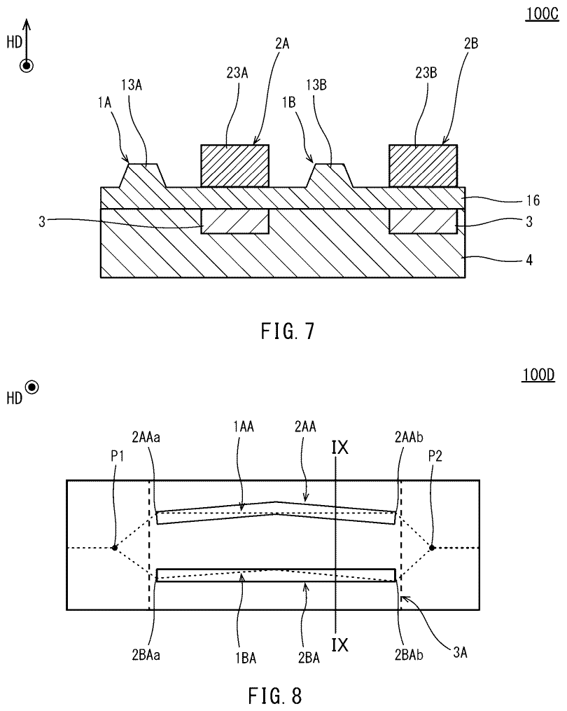

A configuration of an optical modulator 100C according to a fourth example embodiment of the present invention will be described with reference to FIGS. 6 and 7. FIG. 6 is a schematic diagram illustrating a configuration of the optical modulator 100C according to the fourth example embodiment and is a plan view corresponding to FIG. 1. FIG. 7 is a cross-sectional view taken along a line VII-VII in FIG. 6. In other words, FIG. 7 is a cross-sectional view in a case where the optical modulator 100C is cut in a plane along the height direction HD at the positions of the bend portions 13A and 13B of the optical waveguides 1A and 1B. The optical modulator 100C is different from the optical modulator 100 according to the first example embodiment in configurations of the optical waveguide 1A and the first electrode 2A.

As illustrated in FIG. 6, in a view of the optical modulator 100C along the height direction HD, the bend portion 23A of the first electrode 2A has a curved shape that protrudes from the body portions 21A and 22A. The bend portion 23A of the first electrode 2A is located outside of the bend portion 13A of the optical waveguide 1A and substantially does not overlap with the optical waveguide 1A. The bend portion 23A of the first electrode 2A may overlap with the optical waveguide 1A near the body portions 21A and 22A. In this case, as illustrated in FIG. 7, the bend portion 13A of the optical waveguide 1A has a portion separated from the bend portion 23A of the first electrode 2A.

The length of the first electrode 2A is larger than the length of the optical waveguide 1A from the position of the one end portion 21Aa to the position of the other end portion 22Aa of the first electrode 2A in the view along the height direction HD. That is, the length of the first electrode 2A is different from the length of the optical waveguide 1A. Accordingly, the optical modulator 100C according to the fourth example embodiment achieves the same or substantially the same advantageous effects as the optical modulator 100 according to the first example embodiment. Configurations of the optical waveguide 1A and the first electrode 2A in the present example embodiment can also be applied to the optical modulators 100A and 100B according to the second and third example embodiments.

### Fifth Example Embodiment

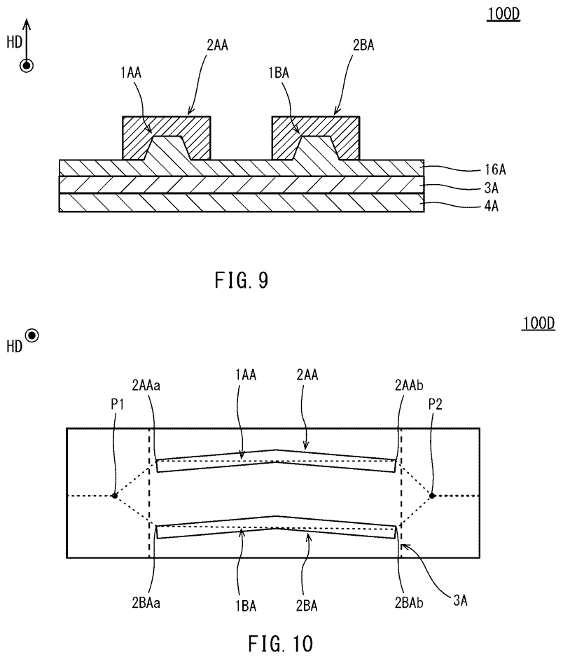

A configuration of an optical modulator 100D according to a fifth example embodiment of the present invention will be described with reference to FIGS. 8 and 9. FIG. 8 is a plan view of the optical modulator 100D according to an eighth example embodiment of the present invention. With reference to FIG. 8, the optical modulator 100D is a Mach-Zehnder optical modulator in the example of the present example embodiment. A basic configuration of the optical modulator 100D is common to that of the optical modulator 100 according to the first example embodiment.

The optical modulator 100D includes two optical waveguides 1AA and 1BA, two first electrodes 2AA and 2BA, and a second electrode 3A. FIG. 8 illustrates the optical waveguides 1AA and 1BA, the first electrodes 2AA and 2BA, and the second electrode 3A that are projected to a plane perpendicular or substantially perpendicular to the height direction HD of the optical modulator 100D. In FIG. 8, the optical waveguides 1AA and 1BA are illustrated by dotted lines, and the second electrode 3A is illustrated by a broken line.

In the optical modulator 100D, the two optical waveguides 1AA and 1BA are located parallel or substantially parallel to each other in the view along the height direction HD. The two first electrodes 2AA and 2BA are located parallel or substantially parallel to each other in the view along the height direction HD. The first electrode 2AA overlaps with the optical waveguide 1AA in a range of one end portion 2AAa to the other end portion 2AAb. The first electrode 2BA overlaps with the optical waveguide 1BA in a range of one end portion 2BAa to the other end portion 2BAb.

In the example of the present example embodiment, the optical waveguide 1AA has a straight shape, and the first electrode 2AA is bent. While the optical waveguide 1AA has a straight shape, the first electrode 2AA is bent. Thus, a length of the first electrode 2AA is larger than a length of the optical waveguide 1AA from a position of the one end portion 2AAa to a position of the other end portion 2AAb of the first electrode 2AA. That is, the length of the first electrode 2AA is different from the length of the optical waveguide 1AA. A bend degree of the first electrode 2AA is relatively small. The bend degree of the first electrode 2AA may be large, and a portion of the optical waveguide 1AA may be separated from the first electrode 2AA by bending of the first electrode 2AA.

The first electrode 2BA has a straight shape, and the optical waveguide 1BA is bent. While the first electrode 2BA has a straight shape, the optical waveguide 1BA is bent. Thus, a length of the first electrode 2BA is smaller than a length of the optical waveguide 1BA from a position of the one end portion 2BAa to a position of the other end portion 2BAb of the first electrode 2BA. That is, the length of the first electrode 2BA is different from the length of the optical waveguide 1BA. A bend degree of the optical waveguide 1BA is relatively small. The bend degree of the optical waveguide 1BA may be large, and a portion of the optical waveguide 1BA may be separated from the first electrode 2BA by bending of the optical waveguide 1BA.

The second electrode 3A is located such that at least a portion of the second electrode 3A overlaps with the optical waveguides 1AA and 1BA and the first electrodes 2AA and 2BA in the view along the height direction HD. For example, in the view along the height direction HD, the second electrode 3A overlaps with the optical waveguides 1AA and 1BA and overlaps with the first electrodes 2AA and 2BA.

FIG. 9 is a cross-sectional view taken along a line IX-IX in FIG. 8. In other words, FIG. 9 is a cross-sectional view in a case where the optical modulator 100D is cut in a plane along the height direction HD at positions of the optical waveguides 1AA and 1BA.

As illustrated in FIG. 9, in the example of the present example embodiment, the optical waveguides 1AA and 1BA are provided in a base layer 16A and protrude from a surface of the base layer 16A. The first electrodes 2AA and 2BA are located on one side in the height direction HD of the optical modulator 100D with respect to the optical waveguides 1AA and 1BA. The second electrode 3A is located on the other side (a side opposite to the first electrodes 2AA and 2BA) in the height direction HD of the optical modulator 100D with respect to each of the optical waveguides 1AA and 1BA. That is, the second electrode 3A is located on different surfaces of the optical waveguides 1AA and 1BA from the first electrodes 2AA and 2BA.

In the optical modulator 100D according to the present example embodiment, the lengths of the first electrodes 2AA and 2BA are set to be different from the lengths of the optical waveguides 1AA and 1BA from the positions of the one end portions 2AAa and 2BAa to the positions of the other end portions 2AAb and 2BAb of the first electrodes 2AA and 2BA. Accordingly, as in the first example embodiment, mismatching between the speed of the electrical signal and the speed of the optical wave can be compensated for.

In the optical modulator 100D according to the present example embodiment, the second electrode 3A is located on a side opposite to the first electrodes 2AA and 2BA with respect to the optical waveguides 1AA and 1BA in the height direction HD of the optical modulator 100D. That is, the second electrode 3A is located on different surfaces of the optical waveguides 1AA and 1BA from the first electrodes 2AA and 2BA. Accordingly, as in the first example embodiment, even in a case where portions of the optical waveguides 1AA and 1BA are separated from the first electrodes 2AA and 2BA in the view along the height direction HD of the optical modulator 100D, unnecessary electric fields are unlikely to be applied to the optical waveguides 1AA and 1BA, and absorption of light can be reduced.

In a case where an optical modulator in which a plurality of electrodes including the first electrode and the second electrode are located on the same surface and the optical waveguide is located between the first electrode and the second electrode in the view along the height direction is used, an interval between the first electrode and the optical waveguide and an interval between the second electrode and the optical waveguide are relatively small. In this case, bending the electrodes with respect to the optical waveguide or bending the optical waveguide with respect to the electrodes brings the electrodes and the optical waveguide into contact with each other. Thus, in such an optical modulator, it is difficult to bend the electrodes or the optical waveguide.

Configurations of the optical waveguides 1AA and 1BA and the first electrodes 2AA and 2BA in the present example embodiment can be applied to the optical modulator 100 according to the first example embodiment. For example, the configurations of the optical waveguides 1AA and 1BA according to the fifth example embodiment can be applied to the body portions 11A, 12A, 11B, and 12B of the optical waveguides 1A and 1B in the first example embodiment. The configurations of the first electrodes 2AA and 2BA in the fifth example embodiment can be applied to the body portions 21A, 22A, 21B, and 22B of the first electrodes 2A and 2B in the first example embodiment. The configurations of the optical waveguides 1AA and 1BA and the first electrodes 2AA and 2BA in the present example embodiment may also be applied to the optical modulators 100A, 100B, and 100C according to the second to fourth example embodiments.

### Modified Examples of Fifth Example Embodiment

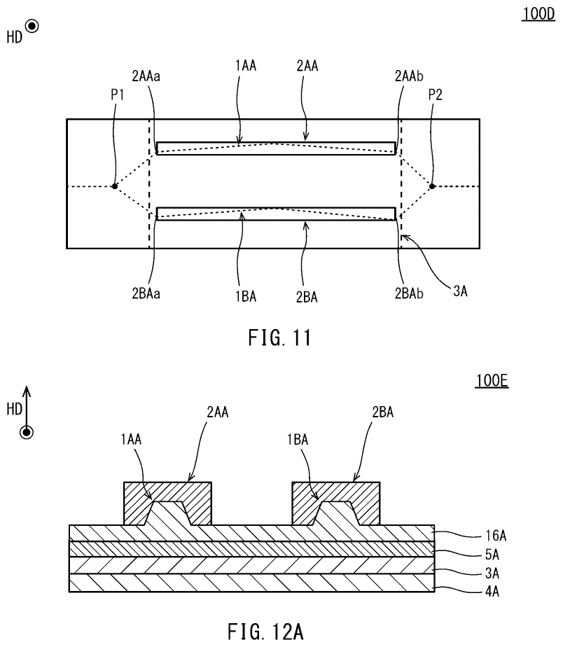

FIGS. 10 and 11 are schematic diagrams illustrating configurations of modified examples of the optical modulator 100D according to the fifth example embodiment and are plan views corresponding to FIG. 8. In the optical modulator 100D illustrated in FIG. 10, in the view along the height direction HD, both of the optical waveguides 1AA and 1BA have a straight shape, and both of the first electrodes 2AA and 2BA are bent. In the optical modulator 100D illustrated in FIG. 11, in the view along the height direction HD, both of the first electrodes 2AA and 2BA have a straight shape, and both of the optical waveguides 1AA and 1BA are bent to the same extent. In any of the optical modulators 100D illustrated in FIGS. 10 and 11, a length between the branch point P1 and the junction point P2 in the optical waveguide 1AA corresponding to both end portions of the optical waveguide 1AA is the same or substantially the same as a length between the branch point P1 and the junction point P2 in the optical waveguide 1BA corresponding to both end portions of the optical waveguide 1BA. Accordingly, the amount of time in which light passes from one end portion to the other end portion can be set to be the same in the two optical waveguides 1AA and 1BA.

### Sixth Example Embodiment

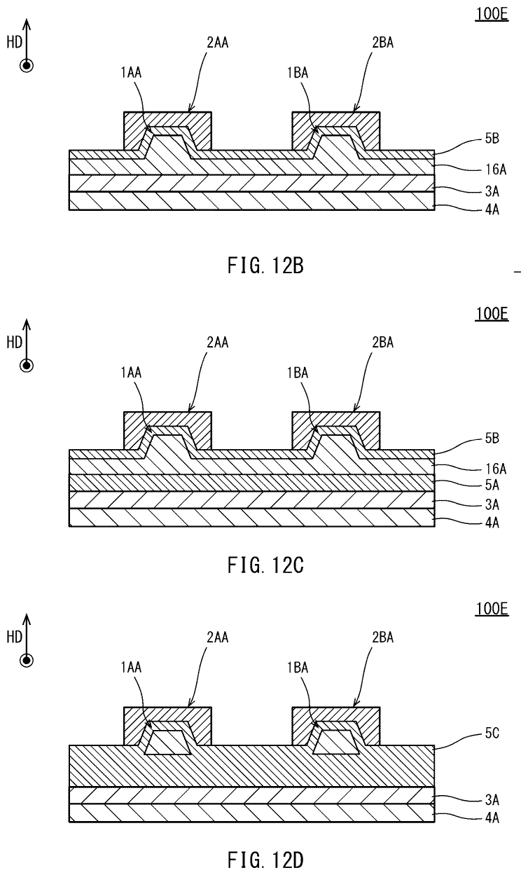

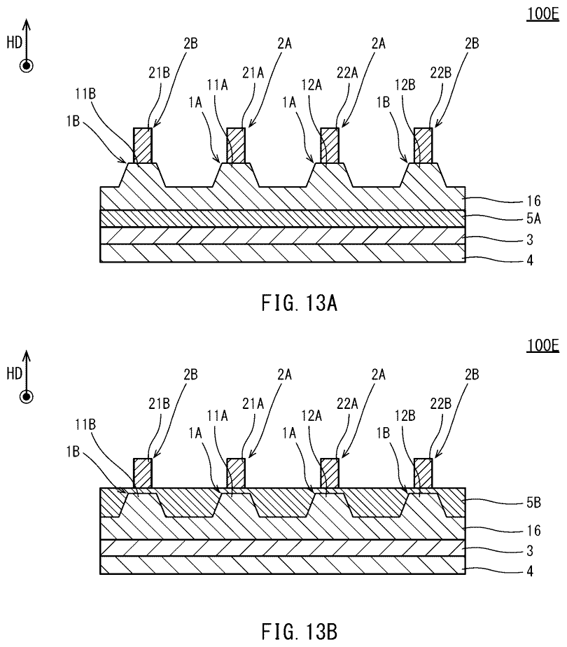

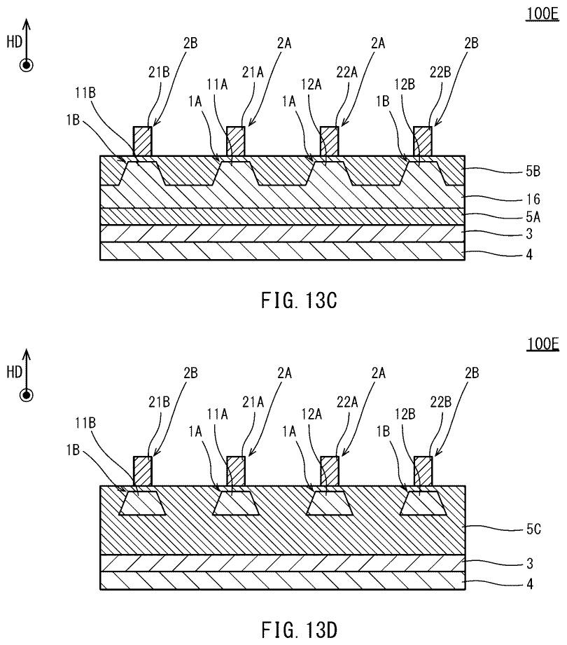

A configuration of an optical modulator 100E according to a sixth example embodiment of the present invention will be described with reference to FIGS. 12A to 12D and 13A to 13D. FIGS. 12A to 12D are schematic diagrams illustrating configurations of the optical modulator 100E according to the sixth example embodiment and are cross-sectional views corresponding to FIG. 9. In other words, FIGS. 12A to 12D are cross-sectional views of the optical modulator 100E obtained by modifying the optical modulator 100D according to the fifth example embodiment and cutting the optical modulator 100E in a plane along the height direction HD at the positions of the optical waveguides 1AA and 1BA. The optical modulator 100E is different from the optical modulator 100D according to the fifth example embodiment in a configuration of including low dielectric constant layers 5A, 5B, and 5C.

The optical modulator 100E illustrated in FIG. 12A includes the optical waveguides 1AA and 1BA, the first electrodes 2AA and 2BA, the second electrode 3A, the low dielectric constant layer 5A, and a support substrate 4A. The low dielectric constant layer 5A has a refractive index smaller than refractive indexes of the optical waveguides 1AA and 1BA. The low dielectric constant layer 5A is uniformly located between the base layer 16A including the optical waveguides 1AA and 1BA and the second electrode 3A in the height direction HD. By installing the low dielectric constant layer 5A on a side closer to the second electrode 3A with respect to the optical waveguides 1AA and 1BA, the effective refractive index of the electrical signal can be reduced compared to that in the optical modulator 100D (FIG. 9) not including a low dielectric constant layer.

The optical modulator 100E illustrated in FIG. 12B includes the optical waveguides 1AA and 1BA, the first electrodes 2AA and 2BA, the second electrode 3A, the low dielectric constant layer 5B, and the support substrate 4A. The low dielectric constant layer 5B has a refractive index smaller than the refractive indexes of the optical waveguides 1AA and 1BA. The low dielectric constant layer 5B is uniformly located between the base layer 16A including the optical waveguides 1AA and 1BA and the first electrodes 2AA and 2BA in the height direction HD. Generally, the first electrodes 2AA and 2BA are used as a signal electrode. In this case, by installing the low dielectric constant layer 5B on a side closer to the first electrodes 2AA and 2BA with respect to the optical waveguides 1AA and 1BA, the effective refractive index of the electrical signal can be reduced compared to that in the optical modulator 100E illustrated in FIG. 12A. This is because filling a surrounding area of the signal electrode with the low dielectric constant layer 5B has a higher effect of reducing the effective refractive index of the electrical signal than installing the low dielectric constant layer 5A on a side closer to the ground electrode.

The optical modulator 100E illustrated in FIG. 12C includes the optical waveguides 1AA and 1BA, the first electrodes 2AA and 2BA, the second electrode 3A, the low dielectric constant layer 5A, the low dielectric constant layer 5B, and the support substrate 4A. In the optical modulator 100E illustrated in FIG. 12C, the low dielectric constant layers 5A and 5B are installed on both of a side closer to the second electrode 3A and a side closer to the first electrodes 2AA and 2BA with respect to the optical waveguides 1AA and 1BA. In this case, the effective refractive index of the electrical signal can be reduced compared to that in the optical modulators 100E illustrated in FIGS. 12A and 12B.

In the optical modulator 100E illustrated in FIG. 12D, the optical waveguides 1AA and 1BA are not provided in the base layer and are independently disposed. That is, in the optical modulator 100E illustrated in FIG. 12D, surrounding areas of the optical waveguides 1AA and 1BA are filled with the low dielectric constant layer 5C. In this case, the effective refractive index of the electrical signal can be reduced compared to that in the optical modulators 100E illustrated in FIGS. 12A to 12C.

In summary, the effective refractive index of the electrical signal is the highest in the optical modulator 100D illustrated in FIG. 9 and is reduced in an order of the optical modulators 100E illustrated in FIGS. 12A, 12B, 12C, and 12D. As the effective refractive index of the electrical signal is reduced, application efficiency of the electric field is reduced.

FIGS. 13A to 13D are schematic diagrams illustrating other configurations of the optical modulator 100E according to the sixth example embodiment and are cross-sectional views corresponding to FIG. 5. In other words, FIGS. 13A to 13D are cross-sectional views of the optical modulator 100E obtained by modifying the optical modulator 100B according to the third example embodiment and cutting the optical modulator 100E in a plane along the height direction HD at the positions of the body portions 11A, 12A, 11B, and 12B of the optical waveguides 1A and 1B. The optical modulators 100E illustrated in FIGS. 13A to 13D are different from the optical modulator 100B according to the third example embodiment in the configuration of including the low dielectric constant layers 5A, 5B, and 5C, as in the optical modulators 100E illustrated in FIGS. 12A to 12D.

The optical modulator 100E illustrated in FIG. 13A includes the optical waveguides 1A and 1B, the first electrodes 2A and 2B, the second electrode 3, the low dielectric constant layer 5A, and the support substrate 4. In the optical modulator 100E illustrated in FIG. 13A, the low dielectric constant layer 5A is installed on a side closer to the second electrode 3 with respect to the optical waveguides 1A and 1B. In this case, the effective refractive index of the electrical signal can be reduced compared to that in the optical modulator 100B (FIG. 5) not including a low dielectric constant layer.

The optical modulator 100E illustrated in FIG. 13B includes the optical waveguides 1A and 1B, the first electrodes 2A and 2B, the second electrode 3, the low dielectric constant layer 5B, and the support substrate 4. In the optical modulator 100E illustrated in FIG. 13B, the low dielectric constant layer 5B is installed on a side closer to the first electrodes 2A and 2B with respect to the optical waveguides 1A and 1B. In this case, the effective refractive index of the electrical signal can be reduced compared to that in the optical modulator 100E illustrated in FIG. 13A.

The optical modulator 100E illustrated in FIG. 13C includes the optical waveguides 1A and 1B, the first electrodes 2A and 2B, the second electrode 3, the low dielectric constant layer 5A, the low dielectric constant layer 5B, and the support substrate 4. In the optical modulator 100E illustrated in FIG. 13C, the low dielectric constant layers 5A and 5B are installed on both of a side closer to the second electrode 3 and a side closer to the first electrodes 2A and 2B with respect to the optical waveguides 1A and 1B. In this case, the effective refractive index of the electrical signal can be reduced compared to that in the optical modulators 100E illustrated in FIGS. 13A and 13B.

In the optical modulator 100E illustrated in FIG. 13D, the optical waveguides 1A and 1B are not provided in the base layer and are independently provided. That is, in the optical modulator 100E illustrated in FIG. 13D, surrounding areas of the optical waveguides 1A and 1B are filled with the low dielectric constant layer 5C. In this case, the effective refractive index of the electrical signal can be reduced compared to that in the optical modulators 100E illustrated in FIGS. 13A to 13C.

In summary, the effective refractive index of the electrical signal is the highest in the optical modulator 100B illustrated in FIG. 5 and is reduced in an order of the optical modulators 100E illustrated in FIGS. 13A, 13B, 13C, and 13D. As the effective refractive index of the electrical signal is reduced, the application efficiency of the electric field is reduced.

In the optical modulators 100E illustrated in FIGS. 13A, 13B, 13C, and 13D, the widths of the first electrodes 2A and 2B are smaller than the widths of the optical waveguides 1A and 1B. However, it is preferable to set the widths of the first electrodes 2A and 2B to be larger than the widths of the optical waveguides 1A and 1B because concentration of the electric field is applied to not only the optical waveguide but also the low dielectric constant layer.

In the optical modulator 100E of the present example embodiment, for example, the effective refractive index of the electrical signal can be set to be smaller than the effective refractive index of the optical wave by adjusting the low dielectric constant layers 5A, 5B, and 5C. In the present specification, the effective refractive index of the electrical signal means an effective refractive index of an electrical signal that passes between the first electrode and the second electrode. The refractive index of the optical wave means an effective refractive index of an optical wave that passes through the optical waveguide. In a case where the effective refractive index of the electrical signal is smaller than the effective refractive index of the optical wave, a loss of the electrical signal can be reduced.

In a case where the effective refractive index of the electrical signal is smaller than the effective refractive index of the optical wave, it is preferable that the length of the first electrode is larger than the length of the optical waveguide. In a case where the length of the first electrode is set to be larger than the length of the optical waveguide, different speeds of the electrical signal and the optical wave can be matched. Consequently, the band width of the optical modulator can be increased, and a high-frequency band of, for example, about 10 GHZ or more and about 1.5 THz or less can be supported.

More specifically, in a case where the effective refractive index of the electrical signal is smaller than the effective refractive index of the optical wave, the speed of the electrical signal is higher than the speed of the optical wave. In this case, in a case where the length of the first electrode is the same as the length of the optical waveguide, that is, the length of the optical waveguide from the position of the one end portion to the position of the other end portion of the first electrode, an amount of time in which the electrical signal passes through the first electrode is smaller than an amount of time in which the optical wave passes through the optical waveguide. Therefore, in a case where the length of the first electrode is set to be larger than the length of the optical waveguide to have the amount of time in which the electrical signal passes through the first electrode close to the amount of time in which the optical wave passes through the optical waveguide, different speeds of the electrical signal and the optical wave can be matched, and higher-speed optical modulation can be performed. For example, an optimal difference in length between the first electrode and the optical waveguide can be calculated using the following expression.

(speed of electrical signal−speed of optical wave)×(length of optical waveguide from position of one end portion to position of other end portion of first electrode)/(speed of electrical signal)

In the optical modulator 100E of the present example embodiment, for example, the effective refractive index of the electrical signal can also be set to be larger than the effective refractive index of the optical wave by adjusting the low dielectric constant layers 5A, 5B, and 5C. In a case where the effective refractive index of the electrical signal is larger than the effective refractive index of the optical wave, application intensity of the electric field to the optical waveguide is further increased. Thus, the driving voltage applied to the first electrode can be reduced.

In a case where the effective refractive index of the electrical signal is larger than the effective refractive index of the optical wave, the application intensity of the electric field to the optical waveguide can be increased even in a case where, for example, the low dielectric constant layers 5A, 5B, and 5C are interposed between the first electrode and the optical waveguide and/or the second electrode and the optical waveguide, by reducing amounts of interposition of the low dielectric constant layers 5A, 5B, and 5C. In this case, the amounts of interposition of the low dielectric constant layers 5A, 5B, and 5C are reduced compared to that of the electro-optical material, and the effective refractive index of the electrical signal mainly depends on the dielectric constant of the electro-optical material. Accordingly, since the effective refractive index of the electrical signal is larger than the effective refractive index of the optical wave, it is unlikely to expand the band of the optical modulator. Therefore, the length of the optical waveguide may be set to be larger than the length of the first electrode with respect to a difference in speed between the electrical signal and the optical wave that has occurred. Accordingly, a difference in speed can be corrected, the optical modulator can be used in a wide band, and a high-frequency band of, for example about 10 GHz or more and about 1.5 THz or less can be supported.

More specifically, in a case where the effective refractive index of the electrical signal is larger than the effective refractive index of the optical wave, the speed of the electrical signal is lower than the speed of the optical wave. In this case, in a case where the length of the first electrode is the same as the length of the optical waveguide, that is, the length of the optical waveguide from the position of the one end portion to the position of the other end portion of the first electrode, the amount of time in which the electrical signal passes through the first electrode is larger than the amount of time in which the optical wave passes through the optical waveguide. Therefore, in a case where the length of the first electrode is set to be smaller than the length of the optical waveguide to have the amount of time in which the electrical signal passes through the first electrode close to the amount of time in which the optical wave passes through the optical waveguide, different speeds of the electrical signal and the optical wave can be matched, and higher-speed optical modulation can be performed. For example, an optimal difference in length between the first electrode and the optical waveguide can be calculated using the following expression.

(speed of optical wave−speed of electrical signal)×(length of first electrode)/(speed of optical wave)

In the optical modulator 100E, the effective refractive index of the electrical signal and the effective refractive index of the optical wave can be determined using the following method. The optical modulator 100E is cut at a middle position between both end portions of the optical waveguide to which the electric field is applied by the first electrode. In the optical modulator 100E, a cross section formed by cutting is observed using a SEM, and a width and a film thickness of each element of the optical waveguide, the low dielectric constant layer, the first electrode, and the second electrode are measured. A refractive index of each element is measured from a measurement result. For example, a critical angle method, a V-block method, a minimum deviation method, or the like can be used to measure the refractive index. The effective refractive indexes at about 10 GHz are calculated using analysis software. An analysis method of the effective refractive indexes is, for example, a finite element method, and COMSOL Multiphysics® (manufactured by COMSOL Inc.) and its wave optics module can be used as the analysis software.

### Seventh Example Embodiment

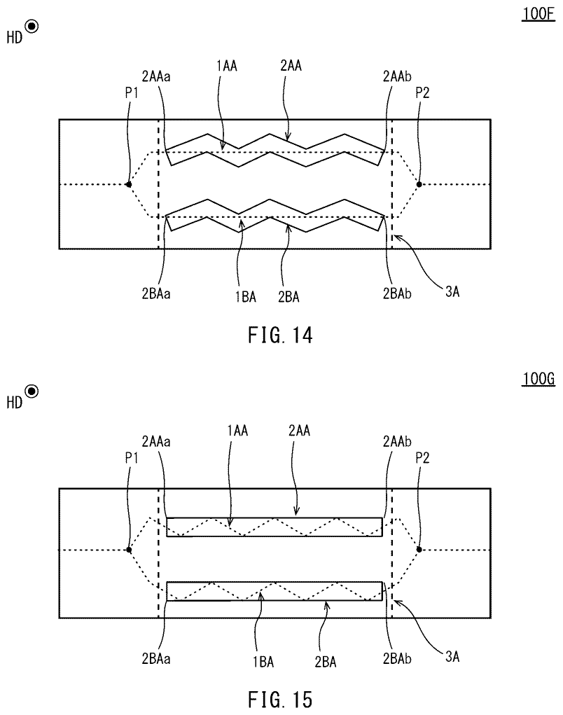

A configuration of an optical modulator 100F according to a seventh example embodiment of the present invention will be described with reference to FIG. 14. FIG. 14 is a schematic diagram illustrating a configuration of the optical modulator 100F according to the seventh example embodiment and is a plan view corresponding to FIG. 8. The optical modulator 100F is different from the optical modulator 100D according to the fifth example embodiment in the configurations of the first electrodes 2AA and 2BA.

As illustrated in FIG. 14, in the optical modulator 100F, the first electrodes 2AA and 2BA overlap with the optical waveguides 1AA and 1BA in the view along the height direction HD. The optical waveguides 1AA and 1BA have a straight shape. The first electrodes 2AA and 2BA include zigzag portions. In the example illustrated in FIG. 14, the first electrodes 2AA and 2BA zigzag over the entire optical waveguides 1AA and 1BA.

Paths of the first electrodes 2AA and 2BA in the zigzag portions have a periodic wave shape. Accordingly, the application intensity of the electric field to the optical waveguides 1AA and 1BA is likely to be uniform along the optical waveguides 1AA and 1BA, and signal quality of optical modulation is improved. Variation in the effective refractive indexes depending on a location can be reduced, and reduction of the band width caused by mismatching between the speeds can be reduced or prevented The lengths of the first electrodes 2AA and 2BA can be set to be larger than the lengths of the optical waveguides 1AA and 1BA. Thus, it is likely to obtain an advantageous effect of compensating for mismatching between the speed of the electrical signal and the speed of the optical wave.

The configurations of the first electrodes 2AA and 2BA in the present example embodiment can be applied to the optical modulator 100 according to the first example embodiment. For example, the configurations of the first electrodes 2AA and 2BA in the seventh example embodiment can be applied to the body portions 21A, 22A, 21B, and 22B of the first electrodes 2A and 2B in the first example embodiment. The configurations of the first electrodes 2AA and 2BA in the present example embodiment may also be applied to the optical modulator according to each of the example embodiments.

### Eighth Example Embodiment

A configuration of an optical modulator 100G according to an eighth example embodiment of the present invention will be described with reference to FIG. 15. FIG. 15 is a schematic diagram illustrating a configuration of the optical modulator 100G according to the eighth example embodiment and is a plan view corresponding to FIG. 8. The optical modulator 100G is different from the optical modulator 100D according to the fifth example embodiment in the configurations of the optical waveguides 1AA and 1BA.

As illustrated in FIG. 15, in the optical modulator 100G, the first electrodes 2AA and 2BA overlap with the optical waveguides 1AA and 1BA in the view along the height direction HD. The first electrodes 2AA and 2BA have a straight shape. The optical waveguides 1AA and 1BA include zigzag portions. In the example illustrated in FIG. 15, the optical waveguides 1AA and 1BA zigzag over the entire the first electrodes 2AA and 2BA.

Paths of the optical waveguides 1AA and 1BA in the zigzag portions have a periodic wave shape. Accordingly, the application intensity of the electric field to the optical waveguides 1AA and 1BA is likely to be uniform along the optical waveguides 1AA and 1BA, and signal quality of optical modulation is improved. Variation in the effective refractive indexes depending on a place can be reduced, and reduction of the band width caused by mismatching between the speeds can be reduced or prevented The lengths of the optical waveguides 1AA and 1BA can be set to be larger than the lengths of the first electrodes 2AA and 2BA. Thus, it is likely to obtain the advantageous effect of compensating for mismatching between the speed of the electrical signal and the speed of the optical wave.

The configurations of the optical waveguides 1AA and 1BA in the present example embodiment can be applied to the optical modulator 100 according to the first example embodiment. For example, the configurations of the optical waveguides 1AA and 1BA according to the eighth example embodiment can be applied to the body portions 11A, 12A, 11B, and 12B of the optical waveguides 1A and 1B in the first example embodiment. The configurations of the optical waveguides 1AA and 1BA in the present example embodiment may also be applied to the optical modulator according to each of the example embodiments.

While the example embodiments according to the present invention have been described above, the present invention is not limited to the example embodiments, and various changes can be made without departing from the scope and gist of the present invention.

What is claimed is:

1. An optical modulator comprising:
an optical waveguide having an electro-optical effect;
a first electrode located on one side in a height direction of the optical modulator with respect to the optical waveguide, including one end portion and another end portion which overlap with at least the optical waveguide in a view along the height direction, and extending from the one end portion to the other end portion; and
a second electrode located on another side in the height direction with respect to the optical waveguide, producing a difference in potential with the first electrode, and to apply an electric field to the optical waveguide together with the first electrode; wherein
in the view along the height direction, a length of the first electrode is different from a length of the optical waveguide from a position of the one end portion to a position of the another end portion.

2. The optical modulator according to claim 1, wherein
two optical waveguides are connected to each other in both end portions;
the first electrode is provided to correspond to each of the optical waveguides; and
the second electrode is provided to correspond to each of the optical waveguides.

3. The optical modulator according to claim 2, wherein
the optical waveguide includes two waveguide body portions and a waveguide bend portion that connects individual ends of the two waveguide body portions to each other;
the first electrode includes two electrode body portions overlapping with the two waveguide body portions, respectively, and an electrode bend portion connecting individual ends of the two electrode body portions to each other and being located inside or outside of the waveguide bend portion in the view along the height direction; and
a length of the electrode bend portion is different from a length of the waveguide bend portion.

4. The optical modulator according to claim 2, wherein, in the view along the height direction, lengths between both the end portions of the two optical waveguides are equal or substantially equal to each other.

5. The optical modulator according to claim 1, wherein an effective refractive index of an electrical signal that passes between the first electrode and the second electrode is smaller than an effective refractive index of an optical wave that passes through the optical waveguide.

6. The optical modulator according to claim 5, wherein the length of the first electrode is larger than the length of the optical waveguide.

7. The optical modulator according to claim 1, wherein the first electrode includes a zigzag portion.

8. The optical modulator according to claim 1, wherein an effective refractive index of an electrical signal that passes between the first electrode and the second electrode is larger than an effective refractive index of an optical wave that passes through the optical waveguide.

9. The optical modulator according to claim 8, wherein the length of the optical waveguide is larger than the length of the first electrode.

10. The optical modulator according to claim 1, wherein the optical waveguide includes a zigzag portion.

11. The optical modulator according to claim 1, further comprising:
an input port located on an end surface of the optical modulator along the height direction to input light into the optical waveguide; and
an output port located on the end surface to output light from the optical waveguide.

12. The optical modulator according to claim 2, wherein the two optical waveguides are bent to be folded.

13. The optical modulator according to claim 2, wherein the two waveguide body portions are located parallel or substantially parallel to each other.

14. The optical modulator according to claim 3, wherein the length of the electrode bend portion is smaller than the length of the waveguide bend portion.
